(19) United States
(12) Patent Application Publication
(10) Pub. No.: US 2014/0013904 A1
(43) Pub. Date: Jan. 16, 2014

(54) RATCHETING PALM GRASPABLE MULTI-SOCKET WRENCH

(71) Applicant: U.S. HOLDINGS CORPORATION, Dallas, TX (US)

(72) Inventor: David Meholovitch, Glendora, CA (US)

(21) Appl. No.: 13/938,040

(22) Filed: Jul. 9, 2013

Related U.S. Application Data
(60) Provisional application No. 61/669,974, filed on Jul. 10, 2012.

(51) Int. Cl. B25B 13/46; B25B 13/06

(52) U.S. Cl. CPC B25B 13/463; B25B 13/06
USPC 81/63.2; 81/63.1

(57) ABSTRACT

A ratcheting palm graspable multi-socket wrench. The wrench includes a socket body portion and a ratcheting mechanism. The socket body portion has socket portions with socket openings, arranged around a perimeter of the socket body portion. A through hole passes through from the top surface to the bottom surface of the socket body portion. The ratcheting mechanism fits into the through hole of the socket body portion. The ratchet mechanism has an elongate shaft with a ratchet switch located at a first end, and a square socket adaptor located at an opposite, second end. The ratchet switch and adaptor are both accessible from outside of the socket body portion. The ratchet switch will selective allow either clockwise or counter-clockwise twisting of the socket body portion to drive the adaptor either clockwise or counter-clockwise, with the other direction being freewheeling, thereby providing a switching ratcheting function.

### CROSS-REFERENCE TO RELATED APPLICATIONS

This application claims the benefit of U.S. Provisional Patent Application No. 61/669,974, filed on Jul. 10, 2012.

### BACKGROUND OF THE INVENTION

The invention relates to palm graspable multi-socket wrenches, and more particularly to a palm graspable multi-socket wrench that includes a ratcheting mechanism to expand its functionality and versatility.

There is a continuing need for more functional and versatile tools. Oftentimes, users need quick access to socket wrenches in order to tighten or loose hex headed bolts and screws without having to search through a tool box or socket set. It is not always apparent what socket size is needed, and further complicating the matter is that frequently the user does not know whether the bolt or screw is SAE or metric. Individual sockets in a set of sockets have at a first end a square-shaped opening with a common size, and a second end with an opening that is sized to connect to a particular sized head of fastener. Depending on the size of the first, square-shaped opening, the sockets will be designated as ¼″, ⅜″, ½″, or ¾″ sockets. The square-shaped openings allow a variety of different sized sockets to be detachably engaged with wretches, extending shafts, universal joints, adaptors, etc., having complementary square male ends. Thus, socket sets remain a popular and versatile tool for many applications.

Besides conventional socket wrenches with elongate wrench handles including wrenches with integral ratcheting mechanism (not shown), there are also available ratcheting palm wrenches (see for example FIG. 1 herein (Prior Art)) that are useful for connecting directly to sockets or via universal joints extender shafts, and the like (not shown). Such ratcheting palm wrenches are useful in tight confines where elongate wrench handles are not appropriate and in applications where the extra mechanical advantage of elongate socket wrenches may not be needed.

The company Thorsen Tool Company (a division of U.S. Holdings Corporation) has offered a palm graspable multi-socket wrench that contains a puck-shaped, hand graspable body portion that contains a number of sockets that are accessible around an outer perimeter of its body portion. The Thorsen Tool Company's palm graspable multi-socket wrench does not contain a protruding square male end, and is not adapted to engage with extending shafts, universal joints, adaptors, etc. Indeed, the sockets of this palm graspable multi-socket wrench are adapted to engage directly to the heads of fasteners. To drive the fastener, the user will need to repeatedly grasp, twist, ungrasp, and repeat.

However, no one has offered a palm graspable multi-socket wrench that incorporates a ratcheting mechanism that allows a user to rotate the palm graspable multi-socket wrench either clockwise or counterclockwise repeatedly without ungrasping the wrench and a turn and then reposition the user's hand.

Moreover, prior palm graspable multi-socket wrench do not include a feature that allows their sockets to be engaged with the heads of fastener to be turned, and also used to drive external sockets.

### SUMMARY OF THE INVENTION

The invention provides a ratcheting palm graspable multi-socket wrench, comprising: a socket body portion having a plurality of socket portions with socket openings, the socket portions being arranged around a perimeter of the socket body portion, the socket body portion having a through hole that passes from a top surface of the socket body portion to a bottom surface of the socket body portion; and a ratcheting mechanism that is fitted into the through hole of the socket body portion, which ratchet mechanism comprises an elongate shaft with a ratchet switch located at a first end, and an adaptor located at an opposite, second end, wherein the ratchet switch and adaptor are both accessible from outside of the socket body portion; wherein the ratchet switch will selective allow either clockwise or counter-clockwise twisting of the socket body portion to drive the adaptor either clockwise or counter-clockwise, with the other direction being freewheeling, thereby providing a switching ratcheting function.

The invention also provides a ratcheting palm graspable multi-socket wrench, comprising: a socket body portion having a plurality of socket portions with socket openings, the socket portions being arranged around a perimeter of the socket body portion, the socket body portion having a through hole that passes from a top surface of the socket body portion to a bottom surface of the socket body portion; a body portion including a top surface, a bottom surface, and a perimeter side, with a plurality of openings that are accessible from the perimeter sides, and a through opening that passes from the top surface to the bottom surface, wherein the body portion is positioned around the socket body portion; a ratcheting mechanism that is fitted into the through hole of the socket body portion, which ratchet mechanism comprises an elongate shaft with a ratchet switch located at a first end, and an adaptor located at an opposite, second end, wherein the ratchet switch and adaptor are both accessible from outside of the socket body portion; wherein the ratchet switch will selective allow either clockwise or counter-clockwise twisting of the socket body portion to drive the adaptor either clockwise or counter-clockwise, with the other direction being freewheeling, thereby providing a switching ratcheting function.

The invention yet further provides a ratcheting palm graspable multi-socket wrench, comprising: a socket body portion having a plurality of socket portions that comprise separate sockets with socket openings, the socket portions being arranged around a perimeter of the socket body portion, the socket body portion having a through hole that passes from a top surface of the socket body portion to a bottom surface of the socket body portion; a body portion including a top surface, a bottom surface, and a perimeter side, with a plurality of openings that are accessible from the perimeter sides, and a through opening that passes from the top surface to the bottom surface, wherein the body portion is positioned around the socket body portion and wherein the separate sockets non-rotatably fit within opening in the perimeter of the body portion; a ratcheting mechanism that is fitted into the through hole of the socket body portion, which ratchet mechanism comprises an elongate shaft with a ratchet switch located at a first end, and a square-shaped male adaptor located at an opposite, second end, wherein the ratchet switch and adaptor are both accessible from outside of the socket body portion; wherein the ratchet switch will selective allow either clockwise or counter-clockwise twisting of the socket body portion to drive the adaptor either clockwise or counter-clockwise, with the other direction being freewheeling, thereby providing a switching ratcheting function.

### BRIEF DESCRIPTION OF THE DRAWINGS

FIG. 1 is a perspective view of a prior art palm drive with a ratcheting mechanism.

FIG. 2 is a bottom perspective view of an exemplary embodiment of a ratcheting palm graspable multi-socket wrench of the invention.

FIG. 3 is a top perspective view of the ratcheting palm graspable multi-socket wrench of FIG. 2.

FIG. 4 is a bottom view of the ratcheting palm graspable multi-socket wrench of FIG. 2.

FIG. 5 is top view of the ratcheting palm graspable multi-socket wrench of FIG. 2.

FIG. 6 is a side perspective view of the ratcheting palm graspable multi-socket wrench of FIG. 2.

FIG. 7 is a side perspective view of the ratcheting palm graspable multi-socket wrench of FIG. 2 engaged with a socket drive extender and a socket wrench.

FIG. 8 is a top perspective view of the puck-shaped body portion of ratcheting palm graspable multi-socket wrench of FIG. 2 with its ratcheting mechanism removed.

FIG. 9 is a perspective view of the racketing mechanism with its ratchet switch in its first position.

FIG. 10 is a perspective view of the racketing mechanism with its ratchet switch in its second position.

FIG. 11 is a top perspective view showing the exemplary embodiment of a ratcheting palm graspable multi-socket wrench of the invention of FIG. 2 with a top portion of the body portion removed to reveal the socket portions.

FIG. 12 is a side perspective view of the ratcheting palm graspable multi-socket wrench of the invention of FIG. 11 showing the optional magnetic socket portion.

FIG. 13A-F show diagrammatic views of a socket portion engaging with various fasteners.

### DETAILED DESCRIPTION

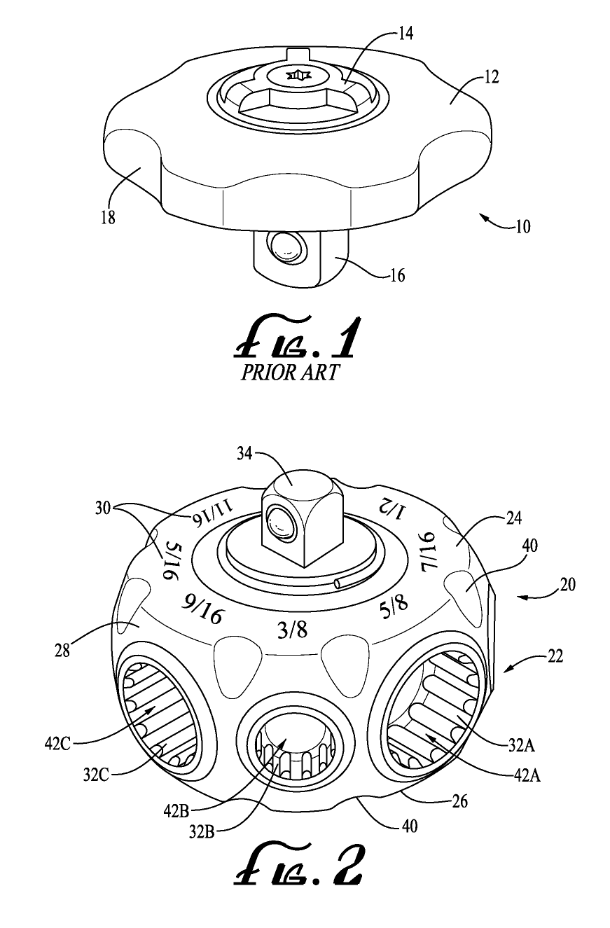

Turning now to the drawings, FIG. 1 is a perspective view of a prior art ratcheting palm drive 10. The prior art ratcheting palm drive 10 includes a body portion 12 with a racket controller 14 at a top, and a square-shaped socket engagement 16 at a bottom thereof. Sides 18 include detents for improved gripping of the palm drive 10. Most nuts, screws, bolts, and bottle caps are tightened (moved away from the observer) by turning them clockwise, and loosened (moved towards the observer) by turning them counterclockwise, in accordance with the right-hand rule. The ratcheting controller 14 is adapted to move between a first position, where only clockwise rotation of the body portion (and not counterclockwise turning) results in clockwise turning of the socket engagement 16 (e.g., to tighten a normally threaded clockwise nut or screw or bolt), and when the body portion 12 is turned counterclockwise, it will freewheel. When the ratcheting controller 14 is in a second position (not shown), only counterclockwise rotation of the body portion 12 results in turning of the socket engagement 16, and clockwise rotation of the body portion 12 results in freewheeling of the socket engagement. The freewheeling feature of ratcheting controllers eliminates the need for a user to repeatedly grasp, turn, ungrasp, reposition the hand, and turn again.

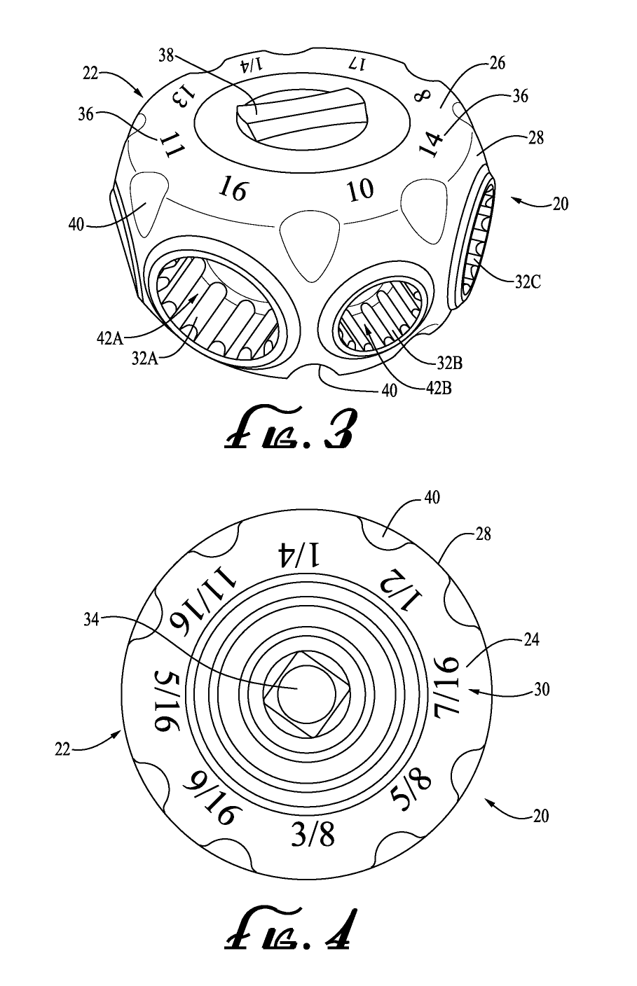

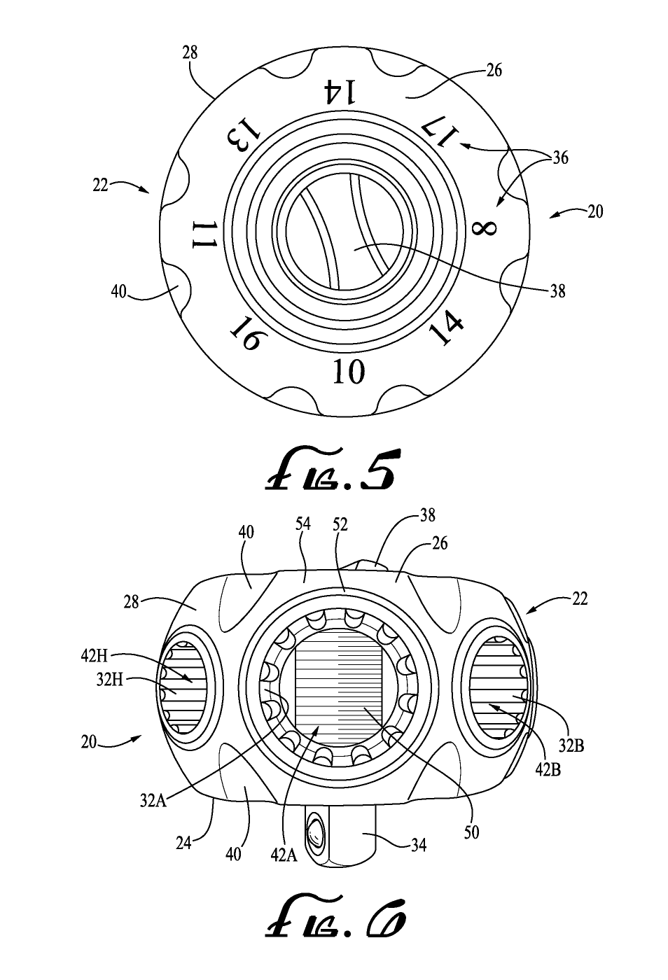

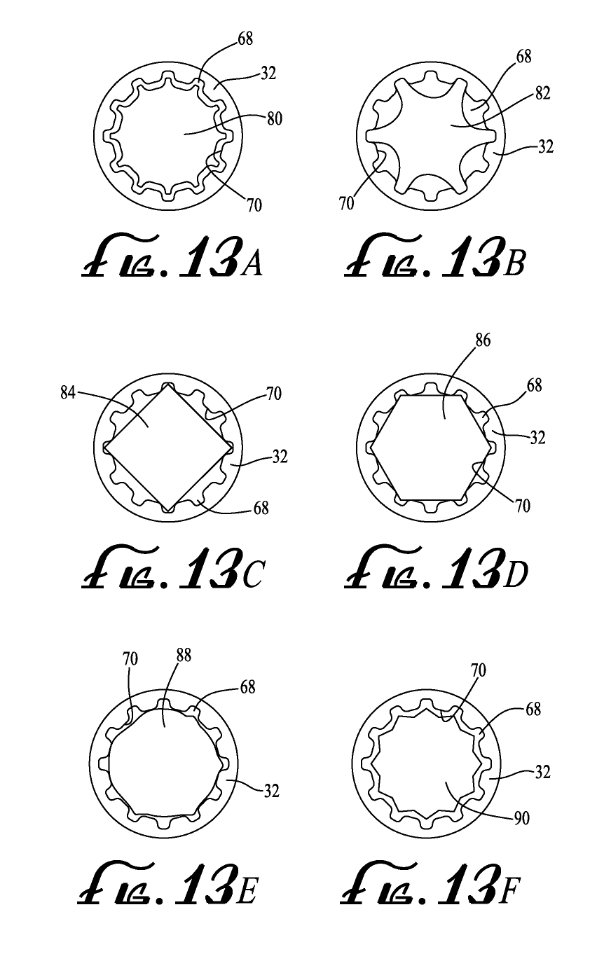

FIGS. 2 and 3 are respectively, bottom and top perspective views of an exemplary embodiment of a ratcheting palm graspable multi-socket wrench 20 of the invention. FIG. 4 is a bottom view and FIG. 5 is top view of the ratcheting palm graspable multi-socket wrench 20. The ratcheting palm graspable multi-socket wrench 20 includes a puck-shaped body portion 22 with a lower surface 24. The body portion 22 has an upper surface 26, and a perimeter side 28. Size indicia 30, such as numbers (e.g., 7/16, ¼, 5/16, etc. (to indicate SAE measurements)) are located (e.g., molded) on the upper surface 26 and designate the SAE nominal sizes of different sized socket portions 32A-H that are arranged for access around the perimeter side 28. The embodiment shown includes eight different sized socket portions, but the ratcheting palm graspable multi-socket wrench 20 of the invention can include a lesser or greater number of socket portions. As best shown in FIG. 12, one of the socket portions 32F can be a ¼′ hex driver (and preferably include a magnet 72 at a bottom well thereof), as this is a common size for fasteners. The individual socket portions 32A-H arranged around the perimeter side 28 are preferably adapted to engage with both SAE and similarly metric sized fastener heads. Openings 68 in the socket portions are be designed with features, such as splines 70, which are designed to engage with fasteners. For example, the same socket portion that fits a ½″ SAE fastener will likewise engage a 13 mm fastener. A square-shaped male adaptor 34 extends from the lower surface 24, and is available for engaging with other sockets, socket extenders, etc. Notches 40 can be formed along with sides to enhance graspability of ratcheting palm graspable multi-socket wrench 20. Size indicia 36, such as numbers (e.g., 11, 8, 14 (to indicate millimeter metric measurements), plus ¼ to indicate ¼″) are located on the upper surface 26 and designate the metric nominal sizes of different sized individual socket portions 32A-H (plus the ¼″ socket) arranged around the perimeter side 28. Extending up from the upper surface 26 is a ratchet switch 38 that controls a ratcheting mechanism located in the puck-shaped body portion 22.

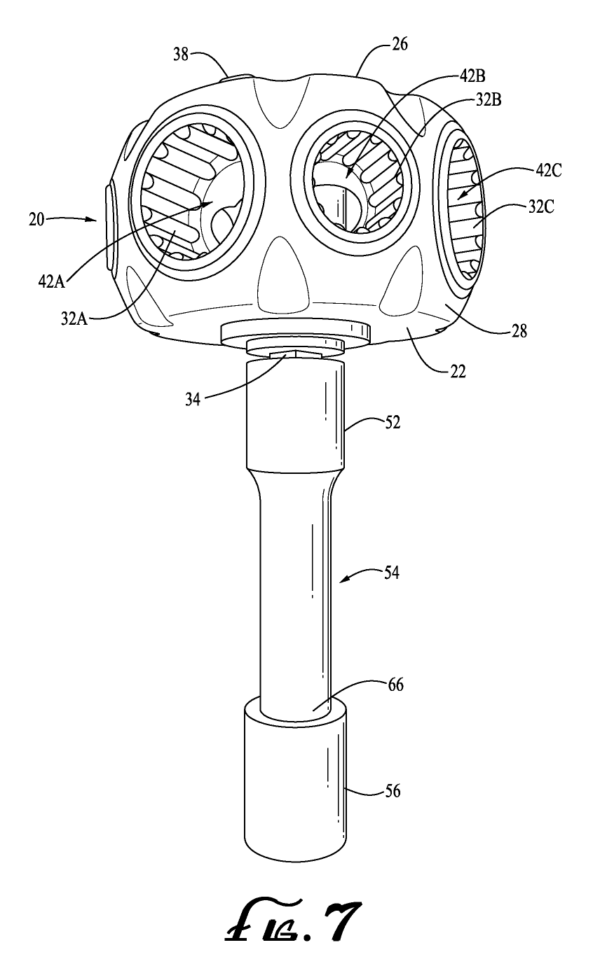

FIG. 6 is a side perspective view of the ratcheting palm graspable multi-socket wrench 20 of FIG. 2. The features shown in FIGS. 2-5 are likewise shown in FIG. 6 plus a portion 50 of the ratcheting mechanism 50 is shown that extends through the palm graspable multi-socket wrench 20. In the construction of the ratcheting palm graspable multi-socket wrench 20, the sockets 32A-H can be formed integrally as a cast metal structure around which hard rubber or plastic 54 is located (e.g., by molding or attachment) for comfortable and slip free handling. Such a structure provides both durability and a simple construction of the tool.

FIG. 7 is a side perspective view of the ratcheting palm graspable multi-socket wrench 20 with its square-shaped male adaptor 34 (just partially shown) engaged with the upper, female end 52 of a drive extender 54. A socket 56 is detachably connected at the drive extender's lower end 66. Used as such, a user can grasp the puck-shaped body portion 22, set the ratchet switch 38 to a desired clockwise or counter-clockwise drive mode, and by twisting his or her wrist, cause the socket 56 to be driven either clockwise or counterclockwise. Moreover, when a user wishes to have extra mechanical advantage when using one of the sockets 32A-H in the tool, the drive extender 54 will function to provide the extra needed mechanical advantage.

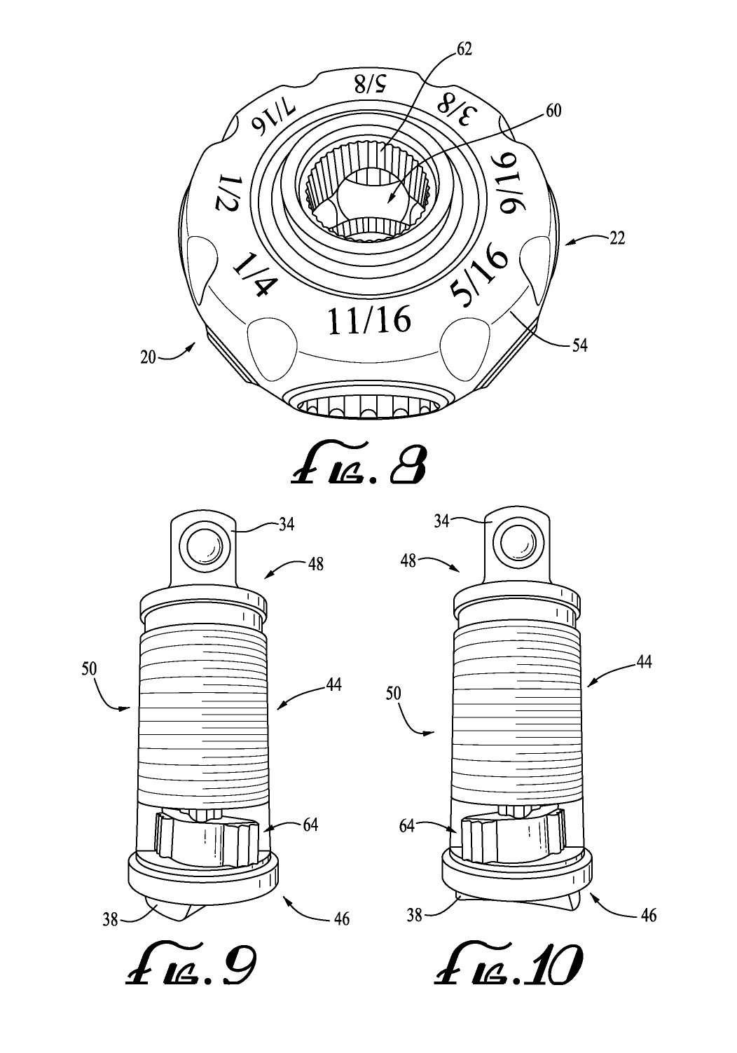

FIG. 8 is a top perspective view of the puck-shaped body portion 22 of ratcheting palm graspable multi-socket wrench 20, with its ratcheting mechanism 50 shown removed. As can be seen, passing through the top 26 and bottom 24 of the puck-shaped body portion 22, is a splined through-hole 60 with splines 62 formed along inner walls thereof. As best shown in FIGS. 11 and 12, the sockets 32A-H in this embodiment can preferably be integrally formed together as a socket body portion 74 around which a shell of hard rubber and/or plastic 76 is preferably molded for comfortable and slip free gripping. The socket body portion 74 is preferably formed of strong material, such as cast metal. However, it is also possible to provide individual sockets that will non-rotatably inserted into the openings formed into the side walls of the body portion 22. Likewise, the through hole with splines can be formed in a separate tube with internal splines that will be placed in the body portion extending from the top to the bottom thereof.

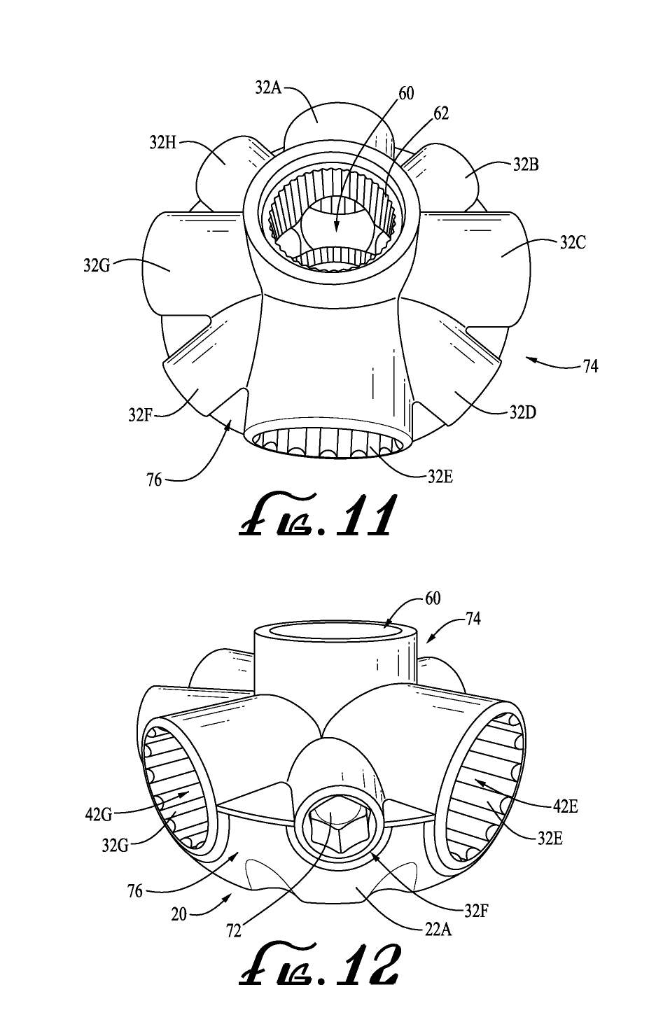

FIG. 9 is a perspective view of the racketing mechanism 50 removed from the puck-shaped body portion 22 of ratcheting palm graspable multi-socket wrench 20, with its ratchet switch 38 in its first position. FIG. 10 is a perspective view of the racketing mechanism 50 with its ratchet switch 38 in its second position. The square-shaped male adaptor 34 extends opposite the ratchet switch 38. The ratcheting mechanism 50 has an elongate shaft 44 with the ratchet switch 38 located at a first end 46, and a square socket adaptor located at an opposite, second end 48. Changing the position of the ratchet switch 38 causes a spring-loaded, toothed cam 64 to move between a first and second position. When the racketing mechanism 50 is placed in splined through hole, depending on the relative position of spring-loaded toothed cam 64, the ratchet switch 38 will selective allow either clockwise or counter-clockwise twisting of the puck-shaped body portion 22 to drive the square-shaped male adaptor 34 either clockwise or counter-clockwise, with the other direction being freewheeling, thereby providing a ratcheting function. Depending on whether the ratcheting palm graspable multi-socket wrench 20 will primarily be used with SAE or metric fasteners, the racketing mechanism 50 can be inserted through either end of the splined through hole 60 so that the SAE measurements or metric measures will selectively be visible at the top of the wrench 20. In FIGS. 2-5, the racketing mechanism 50 is shown inserted through the top end 26 of the puck-shaped body portion 22. Although this particular ratcheting mechanism structure is shown, other currently available ratcheting mechanism can be used instead.

Turning back to FIGS. 11 and 12, FIG. 11 is a top perspective view showing one possible construction of the exemplary embodiment of a ratcheting palm graspable multi-socket wrench 20 of the invention of FIG. 2, but with a bottom portion 22b of the body portion 22 removed to reveal the socket body 74. The top portion 22b of the puck-shaped body portion 22 remains in place. The top portion 22a and 22b can be formed as two halves that are permanently positioned around the socket body portion 74 that carries the separate socket portions 32A-H. The socket body portion 74 is preferably formed of strong material such as steel. The splined through-hole 60 with splines 62 formed along inner walls thereof is shown. The socket body portion 74 shows a structure with eight socket portions 32A-H, however, the socket body portion 74 can comprise fewer, such as at least four socket portions. The at least four socket portions have axes and the socket portions are arranged with their axes in a same plane but offset from each other. At least two socket portions that are offset by about 180 degrees from each other are arranged in pairs.

Straight passageways extend between the two 180 degree offset socket portions. FIG. 12 is a side perspective view of the ratcheting palm graspable multi-socket wrench 20 of the invention of FIG. 11 showing the bottom portion 22b removed to shown socket body portion 74 and showing the optional magnetic socket portion 32f, which can be a ¼″ hex driver, which is shown with an optional magnet 72 at a bottom well thereof. A bottom half of the shell of hard rubber and/or plastic 76 is shown formed around the socket body portion 74.

FIGS. 13A-F are diagrammatic views showing how the socket portions 32 and their openings are adapted to engage with various types of fasteners, including spline 80 (FIG. 13A), Torx® 82 (FIG. 13B), square bolt 84 (FIG. 13C), 6 point (hex) bolt 86 (FIG. 13C), square 88 (FIG. 13D), a damaged 6 point bolt 90 (FIG. 13D), and a 12 point bolt 90 (FIG. 13F). Other spline patterns/openings in the sockets can be used.

Having thus described exemplary embodiments of the present invention, it should be understood by those skilled in the art that the above disclosures are exemplary only and that various other alternatives, adaptations, and modifications may be made within the scope of the present invention. The presently disclosed embodiment is to be considered in all respects as illustrative and not restrictive. The scope of the invention being indicated by the appended claims rather than the foregoing description, and all changes which come within the meaning and range of equivalency of the claims are, therefore, intended to be embraced therein.

What is claimed is:

1. A ratcheting palm graspable multi-socket wrench, comprising:
a socket body portion having a plurality of socket portions with socket openings, the socket portions being arranged around a perimeter of the socket body portion, the socket body portion having a through hole that passes from a top surface of the socket body portion to a bottom surface of the socket body portion; and
a ratcheting mechanism that is fitted into the through hole of the socket body portion, which ratchet mechanism comprises an elongate shaft with a ratchet switch located at a first end, and an adaptor located at an opposite, second end, wherein the ratchet switch and adaptor are both accessible from outside of the socket body portion;
wherein the ratchet switch will selective allow either clockwise or counter-clockwise twisting of the socket body portion to drive the adaptor either clockwise or counter-clockwise, with the other direction being freewheeling, thereby providing a switching ratcheting function.

2. The ratcheting palm graspable multi-socket wrench of claim 1, further comprising a body portion including a top surface, a bottom surface, and a perimeter side, with a plurality of openings that are accessible from the perimeter sides, and a through opening that passes from the top surface to the bottom surface, wherein the body portion is positioned around the socket body portion.

3. The ratcheting palm graspable multi-socket wrench of claim 2, wherein the body portion comprises an upper body portion and a lower body portion, the upper body portion and lower body portion being attached together around the socket body portion with the plurality of socket portions and the through hole being accessible through the body portion, and wherein the body portion comprises pliant material.

4. The ratcheting palm graspable multi-socket wrench of claim 3, wherein the pliant material is selected from the group consisting of plastic and rubber.

5. The ratcheting palm graspable multi-socket wrench of claim 1, wherein the adaptor of the ratcheting mechanism comprises a square-shaped male adaptor.

6. The ratcheting palm graspable multi-socket wrench of claim 1, wherein the through hole has engagements formed on an inside surface thereof, and the ratcheting mechanism further comprises a toothed cam that moves in response to switching of the ratchet switch from a first and second position, and wherein depending on the position of ratchet switch, the spring-loaded toothed cam will be engaged with the engagements formed on an inside surface and the ratchet switch will selective allow either clockwise, or counter-clockwise twisting of the socket body portion to drive the adaptor either clockwise or counter-clockwise, with the other direction being freewheeling, thereby providing a ratcheting function.

7. The ratcheting palm graspable multi-socket wrench of claim 1, wherein the socket body portion comprises at least four socket portions, wherein the at least four socket portions have axes and wherein the socket portions are arranged with their axes in a same plane but offset at about 90 degrees from each other, and wherein at least two socket portions that are offset by about 180 degrees from each other are arranged in pairs, and straight passageways extend between the two 180 degree offset socket portions.

8. The ratcheting palm graspable multi-socket wrench of claim 1, wherein the socket body portion comprises a ¼″ socket with a magnet located at a bottom thereof.

9. The ratcheting palm graspable multi-socket wrench of claim 1, wherein the socket body portion comprises eight socket portions arranged in four pairs of socket portions, wherein each two sockets in a pair are offset from each other by about 180 degrees, and wherein passageways extend through at least two pairs of 180 degree offset socket portions, and wherein the through hole that passes from the top surface of the socket body portion to a bottom surface of the socket body portion intersects the passageways.

10. The ratcheting palm graspable multi-socket wrench of claim 1, wherein socket size indicia is placed on the top surface and bottom surface of the body portion.

11. A ratcheting palm graspable multi-socket wrench, comprising:
a socket body portion having a plurality of socket portions with socket openings, the socket portions being arranged around a perimeter of the socket body portion, the socket body portion having a through hole that passes from a top surface of the socket body portion to a bottom surface of the socket body portion;
a body portion including a top surface, a bottom surface, and a perimeter side, with a plurality of openings that are accessible from the perimeter sides, and a through opening that passes from the top surface to the bottom surface, wherein the body portion is positioned around the socket body portion;
a ratcheting mechanism that is fitted into the through hole of the socket body portion, which ratchet mechanism comprises an elongate shaft with a ratchet switch located at a first end, and an adaptor located at an opposite, second end, wherein the ratchet switch and adaptor are both accessible from outside of the socket body portion;
wherein the ratchet switch will selective allow either clockwise or counter-clockwise twisting of the socket body portion to drive the adaptor either clockwise or counter-clockwise, with the other direction being freewheeling, thereby providing a switching ratcheting function.

12. The ratcheting palm graspable multi-socket wrench of claim 11, wherein the body portion comprises pliant material selected from the group consisting of plastic and rubber.

13. The ratcheting palm graspable multi-socket wrench of claim 11, wherein the adaptor of the ratcheting mechanism comprises a square-shaped male adaptor.

14. The ratcheting palm graspable multi-socket wrench of claim 11, wherein the through hole has engagements formed on an inside surface thereof, and the ratcheting mechanism further comprises a toothed cam that moves in response to switching of the ratchet switch from a first and second position, and wherein depending on the position of ratchet switch, the spring-loaded toothed cam will be engaged with the engagements formed on an inside surface and the ratchet switch will selective allow either clockwise, or counter-clockwise twisting of the socket body portion to drive the adaptor either clockwise or counter-clockwise, with the other direction being freewheeling, thereby providing a ratcheting function.

15. The ratcheting palm graspable multi-socket wrench of claim 11, wherein the socket body portion comprises at least four socket portions, wherein the at least four socket portions have axes and wherein the socket portions are arranged with their axes in a same plane but offset at about 90 degrees from each other, and wherein at least two socket portions that are offset by about 180 degrees from each other are arranged in pairs, and straight passageways extend between the two 180 degree offset socket portions.

16. The ratcheting palm graspable multi-socket wrench of claim 11, wherein the socket body portion comprises eight socket portions arranged in four pairs of socket portions, wherein each two sockets in a pair are offset from each other by about 180 degrees, and wherein passageways extend through at least two pairs of 180 degree offset socket portions, and wherein the through hole that passes from the top surface of the socket body portion to a bottom surface of the socket body portion intersects the passageways.

17. A ratcheting palm graspable multi-socket wrench, comprising:
a socket body portion having a plurality of socket portions that comprise separate sockets with socket openings, the socket portions being arranged around a perimeter of the socket body portion, the socket body portion having a through hole that passes from a top surface of the socket body portion to a bottom surface of the socket body portion;
a body portion including a top surface, a bottom surface, and a perimeter side, with a plurality of openings that are accessible from the perimeter sides, and a through opening that passes from the top surface to the bottom surface, wherein the body portion is positioned around the socket body portion and wherein the separate sockets non-rotatably fit within opening in the perimeter of the body portion;
a ratcheting mechanism that is fitted into the through hole of the socket body portion, which ratchet mechanism comprises an elongate shaft with a ratchet switch located at a first end, and a square-shaped male adaptor located at an opposite, second end, wherein the ratchet switch and adaptor are both accessible from outside of the socket body portion;
wherein the ratchet switch will selective allow either clockwise or counter-clockwise twisting of the socket body portion to drive the adaptor either clockwise or counter-clockwise, with the other direction being freewheeling, thereby providing a switching ratcheting function.

18. The ratcheting palm graspable multi-socket wrench of claim 17, wherein the through hole has engagements formed on an inside surface thereof, and the ratcheting mechanism further comprises a toothed cam that moves in response to switching of the ratchet switch from a first and second position, and wherein depending on the position of ratchet switch, the spring-loaded toothed cam will be engaged with the engagements formed on an inside surface and the ratchet switch will selective allow either clockwise, or counter-clockwise twisting of the socket body portion to drive the adaptor either clockwise or counter-clockwise, with the other direction being freewheeling, thereby providing a ratcheting function.

19. The ratcheting palm graspable multi-socket wrench of claim 17, wherein the socket body portion comprises at least four socket portions, wherein the at least four socket portions have axes and wherein the socket portions are arranged with their axes in a same plane but offset at about 90 degrees from each other, and wherein at least two socket portions that are offset by about 180 degrees from each other are arranged in pairs, and straight passageways extend between the two 180 degree offset socket portions, and wherein the through hole that passes from the top surface of the socket body portion to a bottom surface of the socket body portion intersects the passageways.

20. The ratcheting palm graspable multi-socket wrench of claim 17, wherein the body portion comprises pliant material selected from the group consisting of plastic and rubber.
